(19) United States
(12) Patent Application Publication
(10) Pub. No.: US 2024/0068309 A1
(43) Pub. Date: Feb. 29, 2024

(54) METHOD AND DEVICE FOR REMOVING SEDIMENTS FROM WATER.

(71) Applicant: ASDR Canada Inc., Malartic (CA)

(72) Inventor: Marc Turcotte, Rivière-Héva (CA)

(21) Appl. No.: 18/456,916

(22) Filed: Aug. 28, 2023

Related U.S. Application Data
(60) Provisional application No. 63/374,129, filed on Aug. 31, 2022.

(51) Int. Cl. E21B 21/06; B01D 21/26; C02F 1/52

(52) U.S. Cl. CPC E21B 21/065; B01D 21/26; C02F 1/52; C02F 2103/10

(57) ABSTRACT

A wastewater treatment system for treating water including sediments in suspension. Sediments are removed from the water using a continuous process.

### FIELD OF THE INVENTION

The present invention relates to the general field of wastewater decontamination, and, more particularly, to methods and devices for removing sediments from water.

### BACKGROUND

Water, sometimes with additives added, is used in many processes. For example, in the drilling industry, boreholes are drilled in the ground. Water is injected at the interface between rocks and a drill bit to cool the drill bit and to remove granular material produced during the drilling process. Drilling is often performed far away from infrastructures, and it has been common to use water from a nearby source, such as a lake or a river during the drilling process, and to then release the water back into nature, with or without decontamination treatments. With environmental regulations becoming more stringent, the costs associated with conventional wastewater treatments has increased over the years, to the point where they represent a significant portion of the cost of the drilling operation.

Thus, there is a need in the industry to provide improved methods and devices for treating wastewater, such as water used in drilling and other similar operations. An object of the present invention is therefore to provide such improved methods and devices.

### SUMMARY OF THE INVENTION

In a broad aspect, there is provided a method of recycling contaminated water from a drilling rig, the method comprising: from the drilling rig, receiving in an inlet tank the contaminated water, the contaminated water including sediments in suspension; dispensing agglomerating additives in the inlet tank and mixing the agglomerating additives in the contaminated water contained therein, the agglomerating additives promoting agglomeration of the sediments into larger particles; tapping a tapped portion of the contaminated water from the inlet tank and separating at least a portion of the sediments from the tapped portion to produce treated water and a sludge including the at least a portion of the sediments; and providing the treated water to the drilling rig for use in a drilling operation; wherein the treated water contains less sediments in suspension than the contaminated water.

There may also be provided a method further comprising releasing the treated water to an outlet tank before providing the treated water to the drilling rig from the outlet tank.

There may also be provided a method further comprising dispensing the sludge at a sludge accumulating location.

There may also be provided a method wherein the inlet tank is continuously tapped.

There may also be provided a method wherein the agglomerating additives are continuously dispensed.

There may also be provided a method wherein dispensing agglomerating additives includes dosing the agglomerating additives to maintain a turbidity of the treated water in the outlet tank within a predetermined turbidity range.

There may also be provided a method further comprising providing fresh water to compensate for leaks in a borehole created by the drilling rig.

There may also be provided a method wherein the treated water contains less than about 200 mg/L of total suspended solids (TSS).

There may also be provided a method wherein a concentration of total suspended solids (TSS) in the treated water is at least 100 times less than in the contaminated water.

There may also be provided a method further comprising performing a batch treatment to remove at least part of the sediments in the contaminated water contained in the inlet tank once drilling is completed.

There may also be provided a method further comprising maintaining a pH in the outlet tank within a predetermined pH range.

There may also be provided a method wherein separating the at least a portion of the sediments from the tapped portion is performed using a centrifugal separator.

There may also be provided a method further comprising adding drilling additives to the treated water prior to feeding the treated water to the drilling rig.

In another broad aspect, there is provided a wastewater treatment system for treating contaminated water including sediments in suspension, the system comprising: an inlet for receiving the contaminated water; an inlet tank in a fluid communication relationship with the inlet for storing the contaminated water; an additive dispenser for dispensing agglomerating additives in the inlet tank; a mixer for mixing the agglomerating additives in the contaminated water contained in the inlet tank; a centrifugal separator in a fluid communication relationship with the inlet tank for receiving the contaminated water therefrom and separating the contaminated water in treated water containing no sediments in suspension or less sediments in suspension than the contaminated water and a sludge including sediments removed from the contaminated water; an outlet tank for receiving the treated water; an outlet in a fluid communication relationship with the outlet tank for releasing the treated water; and a sludge dispenser for dispensing the sludge.

There may also be provided a system further comprising a fresh water inlet in fluid communication with at least one of the inlet tank, outlet tank and outlet for providing fresh water to the at least one of the inlet tank, outlet tank and outlet.

There may also be provided a system wherein the sludge dispenser includes at least one of a conveyor and an endless screw.

There may also be provided a system further comprising a controller operative for operating the wastewater treatment system in a continuous process wherein the inlet tank is continuously tapped to feed to centrifugal separator while additional contaminated water is continuously fed to the inlet tank.

There may also be provided a system wherein the controller is further operative to stop the continuous process and perform a batch process to remove a portion of the sediments from substantially the whole contents of the inlet tank.

There may also be provided a system wherein the controller is operative for controlling the additive dispenser to dose the agglomerating additives to maintain a turbidity of the treated water in the outlet tank within a predetermined turbidity range.

In yet another broad aspect, there is provided a closed loop drilling system, comprising: the wastewater treatment system as defined above; and a drilling rig for drilling a borehole, wherein the drilling rig is operatively coupled to the wastewater treatment system to provide the contaminated water produced by the drilling process to the inlet and to receive the treated water from the outlet for feeding the treated water in the borehole.

Advantageously, the proposed system may recycle the contaminated water so that the same water may be reused on a drilling site, and eventually rejected back to the environment once drilling has been completed, while meeting the contaminant requirements of environmental protection legislation and of operating parameters of the drilling rig.

The present application claims benefit from U.S. provisional patent application 63/374,129 filed Aug. 31, 2022, the contents of which is hereby incorporated by reference in its entirety.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a schematic view, illustrates an embodiment of a wastewater treatment system, according to the present invention.

### DETAILED DESCRIPTION

The terms “substantially” and “about” are used throughout this document to indicate variations in the thus qualified terms. These variations are variations that do not materially affect the manner in which the invention works and can be due, for example, to uncertainty in manufacturing processes or to small deviations from a nominal value or ideal shape that do not cause significant changes to the invention.

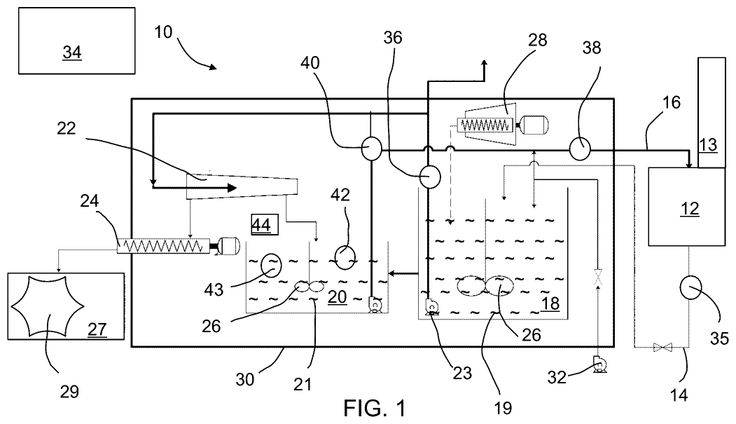

Referring to FIG. 1, there is shown a wastewater treatment system 10 for treating contaminated water 19 including sediments in suspension. For example, the system 10 is used with a drilling rig 12, but the system 10 is also usable in other applications in which there is a need to remove sediments in suspension in a liquid. In some embodiments, contaminated water 19 produced by the drilling rig 12 while drilling a borehole 13 is treated and recycled to be used for further drilling.

The system 10 includes an inlet 14 for receiving the contaminated water 19 and an outlet 16 for releasing treated water 21 after some or all of the sediments have been removed. The inlet 14 and outlet 16 may both be connected through pipes to the drilling rig 12 so that water can be used in a closed circuit, or in a partially closed circuit during a drilling operation. More specifically, the drilling rig 12 is operatively coupled to the wastewater treatment system 10 to provide the contaminated water 19 produced by the drilling process to the inlet 14 and to receive the treated water 21 from the outlet 16 for feeding the treated water 21 in the borehole 13.

The system 10 also includes an inlet tank 18 in a fluid communication relationship with the inlet 14 for storing the contaminated water 19 and an outlet tank 20 for receiving the treated water 21, the outlet 16 being in a fluid communication relationship with the outlet tank 20 for releasing the treated water 21 therefrom. A centrifugal separator 22 is provided between the inlet and outlet tanks 18 and 20. The centrifugal separator 22 receives contaminated water 19 from the inlet tank 18, for example through a pump 23, separates the contaminated water 19 in treated water 21 containing less sediments in suspension than the contaminated water 19 and a sludge 29 including sediments removed from the contaminated water 19, and releases the treated water 21 to the outlet tank 20 while releasing the sludge 29 to a sludge dispenser 24, for example a conveyor, an endless screw or a combination thereof. The sludge dispenser 24 then releases the sludge 29 at a sludge accumulating location 27. In alternative embodiments, other types of separators can be used instead of the centrifugal separator 22.

Typically, mixers 26 are immersed in the inlet and outlet tanks 18 and 20 to continuously mix their contents and any additives that may be added thereto. Also, in some embodiments, the efficiency of the centrifugal separator 22 is improved by introducing additives in the inlet tank 18 through a dispenser 28. The additives are added continuously to the inlet tank 18, but in alternative embodiments, the additives are added intermittently. The additives typically have a composition that promote the agglomeration of the sediments in suspension, and are in these embodiments agglomerating additives. The additives may also help in removing contaminants from the contaminated water 19 or adjust physico-chemical properties of the contaminated water 19, such as its pH or alkalinity. In some embodiments, the treated water 21 is usable directly for further drilling, without requiring any additional treatment. In other embodiments, drilling additives may be added just prior to drilling or in the outlet tank 20.

In some embodiments the system 10 is entirely contained in a conventional shipping container 30, which facilitates handling of the system 10. The shipping container 30 may include all the required mechanical and electrical components necessary for proper operation of the system 10. If required, heating and ventilation systems can also be provided.

In some embodiments, a fresh water inlet 32 leads to one or more of the inlet tank 18, outlet tank 20 and outlet 16 and allows to either prime the system 10 when it is started or to add more water thereto if there are leaks in the drilling process, for example through porous rocks or cracks in the ground. Also, the system 10 may be provided with an auxiliary outlet 36 for releasing treated water 21 to the environment when drilling is completed.

In use, the system 10 receives contaminated water 19 from the drilling rig 12 through the inlet 14 and accumulates this contaminated water 19 in the inlet tank 18. If needed, the agglomerating additives are dispensed to the inlet tank 18 using the additive dispenser 28 and mixed to the contaminated water 19 using the mixer 26. Then, a tapped portion of the contaminated water 19 is tapped from the inlet tank 18 and the centrifugal separator 22 separates at least a portion of the sediments from the tapped portion to produce the treated water 21 and a sludge 29 including the at least a portion of the sediments. In a typical operation, the inlet tank 18 is continuously tapped to feed the contaminated water 19 to the centrifugal separator 22, the latter also operating continuously to treat the contaminated water 19. The treated water 21 is stored in the outlet tank 20 and the sludge 29 is conveyed by the sludge dispenser and accumulated at the sludge accumulating location 27 for subsequent disposal. The treated water 21 can then be fed to the drilling rig 12 from the outlet tank 20. Typically, the rate at which the contaminated water 19 is treated by the centrifugal separator 22 is similar to the rate at which the drilling rig requires new water. In some embodiments, the proposed system 10 can produce treated water 21 having less than about 200 mg/L of total suspended solids (TSS) even when the contaminated water 19 contains more than 100 times this amount of TSS. Also, it was observed that an approximately neutral pH could be maintained.

In this type of operation, the controller 34 is operative for operating the system 10 in a continuous process wherein the inlet tank 18 is continuously tapped to feed to centrifugal separator 22 while additional contaminated water 19 is continuously fed to the inlet tank 18. The controller 34 is operatively coupled to the centrifugal separator 22 to control its rotation speed to achieve a suitable sediment removal from the contaminated water 19 and to the pump 23 to control the flow rate of the latter to maintain the level of the contaminated water 19 in the inlet tank 18 and the level of the treated water 21 in the outlet tank 20 at a suitable level. This control may be predetermined, or modulated using a level sensor indicating the level of the contaminated water 19 in the inlet tank 18 and/or of the treated water 21 in the outlet tank 20.

If needed, once drilling is completed, all the water to be released to the environment can be redirected to the inlet tank 18, and a longer batch process including mixing additional additives to promote agglomeration of sediments can be performed. When this mode is required, the controller 34 is further operative to stop the continuous process, for example by shutting down the pump 23 and the centrifugal separator 22, and perform a batch process to remove a portion of the sediments from substantially the whole contents of the inlet tank 18. In this batch process, after a predetermined amount of time has elapsed during which the various additives act to agglomerate the sediments, the contaminated water 19 is sent to the centrifugal separator 22, which can result in water having relatively low TSS, for example about 30 mg/L or less of TSS. In addition, the agglomeration process can reduce the amount of hydrocarbons and metal in suspension, which can be generated during the drilling process either due to mechanical components wear and tear or due to the use of drilling additives.

It should be noted that the turbidity of the treated water 21 is highly influenced by the rotation speed of the centrifugal separator 22. In water in which no additives have been added, the turbidity is expected to get monotonically lower as rotation speed increases. However, when sediments have been agglomerated, increasing the rotation speed too much will create shear forces that will break the larger agglomerated particles into smaller particles, which are harder to separate through centrifugation. Accordingly, there is a range of optimal speed beyond which turbidity will be increased instead of reduced. In addition, the turbidity of the treated water 21 will depend on the quantity of agglomerating additives that are added to the inlet tank 18. In some embodiments, a nephelometer 43 may be provided at the outlet tank 20 and be operatively coupled to the controller 34 to feed turbidity measurements thereto. Then, the controller 34 may be operatively coupled to the additive dispenser 28 to control a rate at which the agglomerating additives are dispensed so that the controller 34 is operative for controlling the additive dispenser 28 to dose the agglomerating additives to maintain a turbidity of the treated water 21 in the outlet tank within a predetermined turbidity range.

Additional components may be added to the system 10 the enhance its capabilities and user friendliness. The need for user intervention during operation of the system 10 may be reduced by using a controller 34 to automate various aspects of the system 10 so that minimal knowledge about water treatment is required for operation by an intended user. Examples of process automation that may be provided with help of the controller 34 are provided below.

In a first example, operation of the fresh water inlet 32 is automated. Indeed, one may feed information from first, second and third flow meters 35, 36 and 38 to the controller 34, and the later may automatically let water through the fresh water inlet 32 when requires. The first flow meter 35 is be provided between the drilling rig 12 and the inlet tank 18 to measure the flow of water entering the system 10. The second flow meter 36 is be provided between the inlet tank 18 and the centrifugal separator 22 to measure the flow of water transferred between the inlet and outlet tanks 18 and 20. The third flow meter 38 is provided between the outlet tank 20 and the drilling rig 12 to measure the flow of water exiting the outlet tank 20. Using the measurements taken by the first, second and third flow meters 35, 36 and 38, the controller may determine when the water level in the inlet or outlet tanks 18 or 20 becomes too low, using differences in flow rates, and control admission of water through the fresh water inlet 32 and the flow rate of the pump 23 to raise these levels when too low.

In a second example, a three-way valve 40 may be provided between the outlet tank 20 and the drilling rig 12. When combined with appropriate piping leading to the water input of the centrifugal separator 22, the three-way valve 40 may redirect the treated water 21 either towards the drilling rig 12 or back towards the centrifugal separator 22. In the latter case, when combined with stopping of the pump 23, clean water may be flushed through the centrifugal separator for cleaning, for example is the centrifugal separator becomes clogged. Clogging may be detected by internal mechanisms of the centrifugal separator or any other suitable sensor that feeds the required signals to the controller 34, which can then control the above-described flushing, for example for a predetermined duration, before resuming flow of the treated water 21 towards the drilling rig 12.

A pH monitor 42 may be provided in the outlet tank 20 to monitor the quality of the treated water 21. This pH may be provided to the controller 34, which may issue an alarm when this pH is outside of predetermined parameters, for example a visual alarm in the form of a flashing light, an audible alarm, or an electronic alarm sending a message to an outside device.

In some embodiments, some or all of the various additives added to water during the drilling process are removed from the contaminated water 19 while the system 10 operates. These additives may be added back to the treated water 21 in the outlet tank using a suitable doser 44 controlled by the controller 34, for example at a fixed weight or volume per volume of water entering the outlet tank 20. In some embodiments, the drilling additives influence the conductivity of the water, and using conductivity measurements fed to the controller 34, the rate at which the additives are added can be adjusted by the controller 34, which then controls the doser 44 to maintain this conductivity within a predetermined range.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is:

1. A method of recycling contaminated water from a drilling rig, the method comprising:
from the drilling rig, receiving in an inlet tank the contaminated water, the contaminated water including sediments in suspension;
dispensing agglomerating additives in the inlet tank and mixing the agglomerating additives in the contaminated water contained therein, the agglomerating additives promoting agglomeration of the sediments into larger particles;
tapping a tapped portion of the contaminated water from the inlet tank and separating at least a portion of the sediments from the tapped portion to produce treated water and a sludge including the at least a portion of the sediments; and
providing the treated water to the drilling rig for use in a drilling operation;
wherein the treated water contains less sediments in suspension than the contaminated water.

2. The method as defined in claim 1, further comprising releasing the treated water to an outlet tank before providing the treated water to the drilling rig from the outlet tank.

3. The method as defined in claim 1, further comprising dispensing the sludge at a sludge accumulating location.

4. The method as defined in claim 1, wherein the inlet tank is continuously tapped.

5. The method as defined in claim 4, wherein the agglomerating additives are continuously dispensed.

6. The method as defined in claim 5, wherein dispensing agglomerating additives includes dosing the agglomerating additives to maintain a turbidity of the treated water in the outlet tank within a predetermined turbidity range.

7. The method as defined in claim 1, further comprising providing fresh water to compensate for leaks in a borehole created by the drilling rig.

8. The method as defined in claim 1, wherein the treated water contains less than about 200 mg/L of total suspended solids (TSS).

9. The method as defined in claim 1, wherein a concentration of total suspended solids (TSS) in the treated water is at least 100 times less than in the contaminated water.

10. The method as defined in claim 1, further comprising performing a batch treatment to remove at least part of the sediments in the contaminated water contained in the inlet tank once drilling is completed.

11. The method as defined in claim 1, further comprising maintaining a pH in the outlet tank within a predetermined pH range.

12. The method as defined in claim 1, wherein separating the at least a portion of the sediments from the tapped portion is performed using a centrifugal separator.

13. The method as defined in claim 1, further comprising adding drilling additives to the treated water prior to feeding the treated water to the drilling rig.

14. A wastewater treatment system for treating contaminated water including sediments in suspension, the system comprising:
an inlet for receiving the contaminated water;
an inlet tank in a fluid communication relationship with the inlet for storing the contaminated water;
an additive dispenser for dispensing agglomerating additives in the inlet tank;
a mixer for mixing the agglomerating additives in the contaminated water contained in the inlet tank;
a centrifugal separator in a fluid communication relationship with the inlet tank for receiving the contaminated water therefrom and separating the contaminated water in treated water containing no sediments in suspension or less sediments in suspension than the contaminated water and a sludge including sediments removed from the contaminated water;
an outlet tank for receiving the treated water;
an outlet in a fluid communication relationship with the outlet tank for releasing the treated water; and
a sludge dispenser for dispensing the sludge.

15. The wastewater treatment system as defined in claim 14, further comprising a fresh water inlet in fluid communication with at least one of the inlet tank, outlet tank and outlet for providing fresh water to the at least one of the inlet tank, outlet tank and outlet.

16. The wastewater treatment system as defined in claim 14, wherein the sludge dispenser includes at least one of a conveyor and an endless screw.

17. The wastewater treatment system as defined in claim 14, further comprising a controller operative for operating the wastewater treatment system in a continuous process wherein the inlet tank is continuously tapped to feed to centrifugal separator while additional contaminated water is continuously fed to the inlet tank.

18. The wastewater treatment system as defined in claim 17, wherein the controller is further operative to stop the continuous process and perform a batch process to remove a portion of the sediments from substantially the whole contents of the inlet tank.

19. The wastewater treatment system as defined in claim 17, wherein the controller is operative for controlling the additive dispenser to dose the agglomerating additives to maintain a turbidity of the treated water in the outlet tank within a predetermined turbidity range.

20. A closed loop drilling system, comprising:
the wastewater treatment system as defined in claim 14; and
a drilling rig for drilling a borehole, wherein the drilling rig is operatively coupled to the wastewater treatment system to provide the contaminated water produced by the drilling process to the inlet and to receive the treated water from the outlet for feeding the treated water in the borehole.
